(19) United States
(12) Patent Application Publication
(10) Pub. No.: US 2018/0300832 A1
(43) Pub. Date: Oct. 18, 2018

(54) INSPECTION MANAGEMENT FOR ENERGY OPERATIONS

(71) Applicant: Knights Inspection Services, LLC, Montgomery, TX (US)

(72) Inventors: Clint Knight, Montgomery, TX (US); Troy Blanchard, Conroe, TX (US); Derrick Whiteside, Magnolia, TX (US)

(21) Appl. No.: 15/489,678

(22) Filed: Apr. 17, 2017

(51) Int. Cl. G06Q 50/26; G06Q 30/04; G06Q 30/02; G06Q 30/06

(52) U.S. Cl. CPC G06Q 50/265; G06Q 30/04; G06Q 10/10; G06Q 30/0611; G06Q 30/0283

(57) ABSTRACT

A method of inspection management for energy operations includes receiving a request for quotation for an inspection job from a client, determining initial job information from the request and predetermined information stored in a database, preparing a quotation for the inspection job, providing access to the quotation to the client, determining an approval status of the quotation, receiving detailed job information from an inspector, preparing one or more job reports for the inspection job, storing the one or more job reports in the database, providing access to the one or more job reports, preparing a billing authorization for the inspection job, and providing access to the billing authorization to the client.

### BACKGROUND OF THE INVENTION

The exploration and production of energy typically includes the fabrication, procurement, installation, commissioning, and operation of various tools, equipment, and systems on a project-by-project basis. Because of the complexity involved, these types of projects require the cooperative efforts of a number of specialized companies including, but not limited to, an operator, a contractor, and a number of service companies. The operator is typically the party in charge of planning, designing, and managing the operations and is usually the holder of the mineral rights that sells the end product into the market. The operator engages the services of a contractor to perform the drilling or recovery operations. In turn, the contractor engages the services of a number of service companies, consultants, and other third-parties to provide materials, tools, equipment, and systems and perform various tasks related to the operations. As such, a typical energy project may include the cooperative efforts of more than a dozen different companies and hundreds of individual contributors.

Inspectors are typically subcontracted to inspect and test the materials, tools, equipment, and systems used to ensure that the project meets contractual requirements, technical specifications, and quality standards as well as comply with various safety and regulatory requirements. The types of materials, tools, equipment, and systems that are inspected may include, but are not limited to, ground rig structures and sub-structures, over water structures and sub-structures, cranes, casings, drill string, drill pipe, pipe racks, pipe tubs, tubulars, pipelines, derricks, masts, platforms, valves, tanks, vessels, pressure equipment, blow out prevention equipment, downhole assemblies, generators, bearings, motors, drill bits, lighting, centrifuges, fluid systems, hydraulic systems, and electrical systems. In certain types of operations, such as, hydraulic fracturing operations, there may be additional regulations relating to pre-drilling water well testing, cement barriers protecting water aquifers, liners required for fluid storage pits, and analysis of fracking fluids, each of which may require further inspection.

### BRIEF SUMMARY OF THE INVENTION

According to one aspect of one or more embodiments of the present invention, a method of inspection management for energy operations includes receiving a request for quotation for an inspection job from a client, determining initial job information from the request and predetermined information stored in a database, preparing a quotation for the inspection job, providing access to the quotation to the client, determining an approval status of the quotation, receiving detailed job information from an inspector, preparing one or more job reports for the inspection job, storing the one or more job reports in the database, providing access to the one or more job reports, preparing a billing authorization for the inspection job, and providing access to the billing authorization to the client.

According to one aspect of one or more embodiments of the present invention, a non-transitory computer readable medium comprising software instructions that, when executed by a processor, performs a method of inspection management for energy operations that includes receiving a request for quotation for an inspection job from a client, determining initial job information from the request and predetermined information stored in a database, preparing a quotation for the inspection job, providing access to the quotation to the client, determining an approval status of the quotation, receiving detailed job information from an inspector, preparing one or more job reports for the inspection job, storing the one or more job reports in the database, providing access to the one or more job reports, preparing a billing authorization for the inspection job, and providing access to the billing authorization to the client.

Other aspects of the present invention will be apparent from the following description and claims.

### BRIEF DESCRIPTION OF THE DRAWINGS

FIG. 1 shows a computing system in accordance with one or more embodiments of the present invention.

FIG. 2 shows a diagram of an inspection management system for energy operations in accordance with one or more embodiments of the present invention.

FIG. 3 shows a method of inspection management for energy operations in accordance with one or more embodiments of the present invention.

FIG. 4 shows a method of client interaction with an inspection management system for energy operations in accordance with one or more embodiments of the present invention.

FIG. 5 shows a method of inspector interaction with an inspection management system for energy operations in accordance with one or more embodiments of the present invention.

FIG. 6 shows a dashboard user-interface of an inspection management system for energy operations in accordance with or more embodiments of the present invention.

FIG. 7 shows a quotations user-interface of an inspection management system for energy operations in accordance with or more embodiments of the present invention.

FIG. 8 shows an inspections user-interface of an inspection management system for energy operations in accordance with or more embodiments of the present invention.

FIG. 9 shows an inspection header user-interface of an inspection management system for energy operations in accordance with or more embodiments of the present invention.

FIG. 10 shows a job safety analysis user-interface of an inspection management system for energy operations in accordance with or more embodiments of the present invention.

FIG. 11 shows a safety observation checklist user-interface of an inspection management system for energy operations in accordance with or more embodiments of the present invention.

FIG. 12 shows an inspection report user-interface of an inspection management system for energy operations in accordance with or more embodiments of the present invention.

FIG. 13 shows an inspection photos user-interface of an inspection management system for energy operations in accordance with or more embodiments of the present invention.

FIG. 14 shows a billing authorization user-interface of an inspection management system for energy operations in accordance with or more embodiments of the present invention.

### DETAILED DESCRIPTION OF THE INVENTION

One or more embodiments of the present invention are described in detail with reference to the accompanying figures. For consistency, like elements in the various figures are denoted by like reference numerals. In the following detailed description of the present invention, specific details are set forth in order to provide a thorough understanding of the present invention. In other instances, well-known features to one of ordinary skill in the art are not described to avoid obscuring the description of the present invention.

As discussed above, energy projects typically require the cooperative efforts of more than a dozen different companies and hundreds of individual contributors. The contractor will typically engage the services of a number of different inspection companies to provide inspection services over the lifetime of the project and those inspections typically result in the production of paper inspection reports. The inspection companies may or may not maintain the inspection reports and, in the event they do maintain them, they are typically filed off in paper, without backup or electronic access. Moreover, the inspection companies are distinct entities that do not communicate or share information with one another, even when working on the same project. As such, at the inspection company level, there is little to no ability to comprehend the inspection coverage for a project.

While the contractor, as recipient of the various inspection reports, is in the best possible position to gather, organize, and provide access to such inspection reports, they engage the services of a large number of service providers, consultants, and third-parties and typically do not have any coherent policy, process, or system in place for retaining, organizing, and communicating inspection results. Internally, the contractor typically does not even have the ability to quickly and easily evaluate the state of the inspections that have already been performed or those that need to be performed for a given project. Not surprisingly, the operator has even less visibility to these inspection reports, which further complicates the ability of the operator to provide any manner of oversight that they may wish to exert over the project, including critical safety and quality controls.

While an underlying goal of inspection services is to prevent the occurrence of undesirable events, accidents and failures in the field can cause injury to personnel and have environmental consequences. Unfortunately, it is only after such an undesirable event has occurred that there is any effort to locate, gather, and organize the inspection reports related to the incident. If they can be located, these inspection reports are critical to identifying what went wrong and why. Historically, investigations into serious accidents, such as, for example, the Deepwater Horizon accident, have highlighted the lack of coherent ability for the operator and the contractor to manage inspection services and meet quality and safety objectives. At best, this information failure impedes the ability of the operator and the contractor to perform their operations in the safest and most efficient manner. However, at worst, this information failure can result in injury or death and damage to the environment.

In response to such high profile incidents, trade associations, such as, for example, the American Petroleum Institute (“API”), have promulgated various standards related to maintenance, inspection, and test programs. Specifically, the API has promulgated API Specification Q1 and, more recently, API Specification Q2 which seeks to standardize service quality and risk mitigation efforts supported by validation and tracking of actual service provider performance. Operators and contractors are at present having difficulty complying with API Specification Q2 because they lack a coherent policy, process, or system to manage inspection related services that is centrally located, provides appropriate access to users, and maintains detailed records for posterity.

As such, there has been a long felt, but unsolved need, in the industry to coherently gather, organize, and provide access to various inspection related events, documents, and results as well as maintain records for regulatory and standards compliance. The failure of industry to do so has resulted in undesirable incidents that have resulted in the loss of life and considerable damage to the environment.

Accordingly, in one or more embodiments of the present invention, inspection management for energy operations provides a coherent way of gathering, organizing, and providing access to various inspection reports. Such methods and systems provide a comprehensive solution for tracking and tracing equipment and inspection services by integrating quotation approval, inspection services, quality, safety, reporting, documenting, and billing activities within a database that allows appropriate access to users including, potentially, operators, contractors, service providers, inspectors, and regulatory staff. Advantageously, inspection management for energy operations provides operators, contractors, and service providers a comprehensive solution that facilitates compliance with API Specification Q1 and Q2.

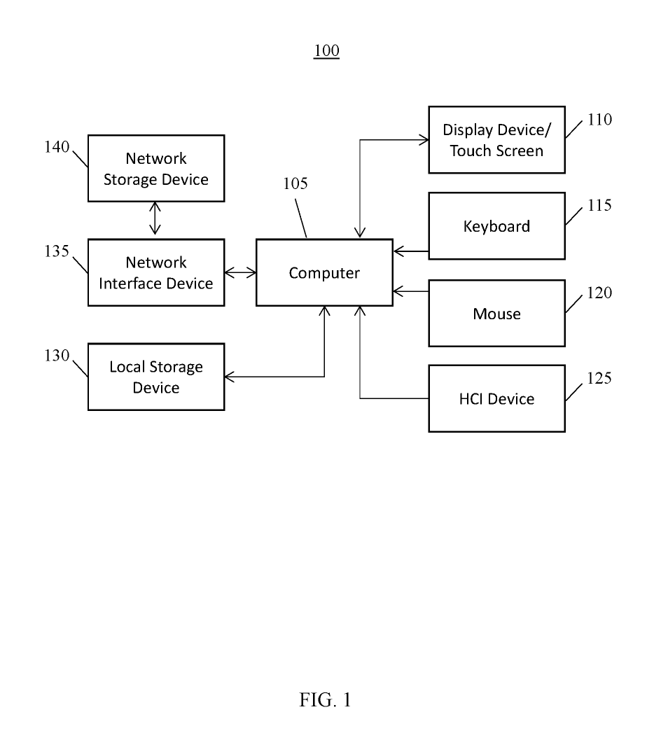

FIG. 1 shows a computing system 100 in accordance with one or more embodiments of the present invention. Computing system 100 may include one or more computers 105 that each includes one or more printed circuit boards (not shown) or flex circuits (not shown) on which one or more processors (not shown) and system memory (not shown) may be disposed. Each of the one or more processors may be a single-core processor (not shown) or a multi-core processor (not shown). Multi-core processors typically include a plurality of processor cores (not shown) disposed on the same physical die or a plurality of processor cores disposed on multiple die that are disposed in the same mechanical package. Computing system 100 may include one or more input/output devices such as, for example, a display device 110, keyboard 115, mouse 120, and/or any other human-computer interface device 125. The one or more input/output devices may or may not be integrated into computer 105. Display device 110 may be a touch screen that includes a touch sensor (not shown) configured to sense touch.

Computing system 100 may include one or more local storage devices 130. Local storage device 130 may be a solid-state memory device, a solid-state memory device array, a hard disk drive, a hard disk drive array, or any other non-transitory computer readable medium. Local storage device 130 may be integrated into computer 105. Computing system 100 may include one or more network interface devices 140 that provide a network interface to computer 105. The network interface may be Ethernet, Wi-Fi, Bluetooth, WiMAX, Fibre Channel, or any other network interface suitable to facilitate networked communications. Computing system 100 may include one or more network-attached storage devices 140 in addition to, or instead of, one or more local storage devices 130. Network-attached storage device 140 may be a solid-state memory device, a solid-state memory device array, a hard disk drive, a hard disk drive array, or any other non-transitory computer readable medium. Network-attached storage device 150 may or may not be collocated with computer 105 and may be accessible to computer 105 via one or more network interfaces provided by one or more network interface devices 135. One of ordinary skill in the art will recognize that computer 105 may be a cloud-based server, a server, a workstation, a desktop, a laptop, a netbook, a tablet, a smartphone, a mobile device, and/or any other type of computing system in accordance with one or more embodiments of the present invention.

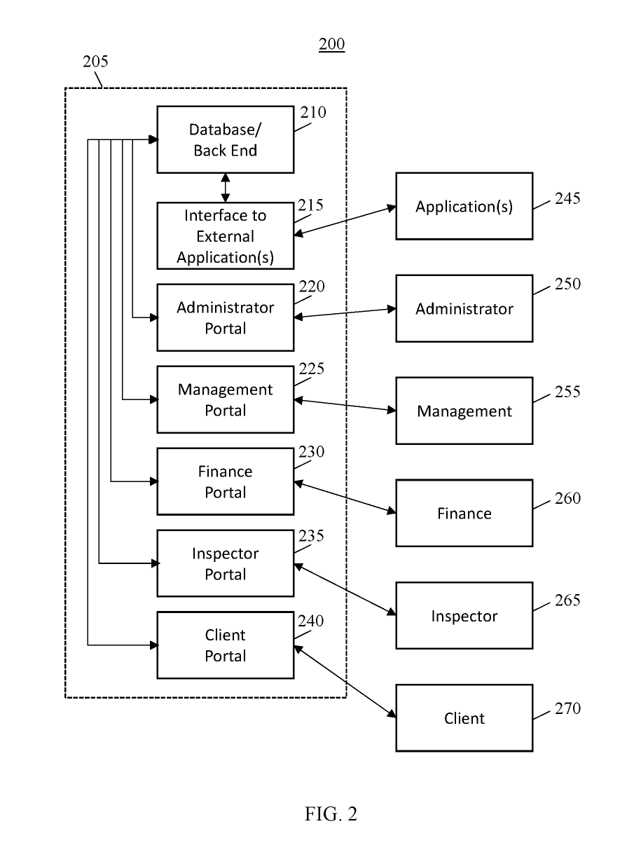

In certain embodiments, an inspection management system (200 of FIG. 2) may include a virtual server 100 configured to execute an inspection management application (205 of FIG. 2) that may be instantiated in a cloud-based server such as those provided by, for example, Amazon AWS®, Microsoft Azure®, Google Cloud®, or other cloud computing service providers. In such embodiments, the components of virtual server 100 may be distributed in a manner that is transparent, but potentially unknown, to the end user. Advantageously, cloud-based servers typically provide physical isolation, fault tolerance, redundancy, and automated backup mechanisms that protect the integrity of data stored therein. In other embodiments, inspection management system (200 of FIG. 2) may include a physical server 100 configured to execute an inspection management application (205 of FIG. 2) that may be hosted by a third party. In still other embodiments, inspection management system (200 of FIG. 2) may include a physical server 100 configured to execute an inspection management application (205 of FIG. 2) that may be hosted internally within the organization. Common to the various embodiments, server 100 may provide access to various users (e.g., 250, 255, 260, 265, and 270 of FIG. 2) via one or more web portals (e.g., 220, 225, 230, 235, and 240 of FIG. 2) of the inspection management application (205 of FIG. 2) that are accessed via a web interface of their respective computing system 100. Users may access the inspection management application (205 of FIG. 2), or those portions that they are allowed access to, via any computing system 100 that provides such web access. One of ordinary skill in the art will recognize that other types and combinations of computing systems 100 may be used on the client or server side in accordance with one or more embodiments of the present invention.

FIG. 2 shows a diagram of an inspection management system 200 for energy operations in accordance with one or more embodiments of the present invention. Inspection management system 200 may include an inspection management application 205 that resides on, and executes from, a server (e.g., 100 of FIG. 1) and one or more remote computing systems (e.g., 100 of FIG. 1) that provides one or more users (e.g., 250, 255, 260, 265, and 270) web-based access to one or more web portals (e.g., 220, 225, 230, 235, and 240) of the inspection management application 205. As discussed above, the server (e.g., 100 of FIG. 1) may be a cloud-based virtual server or physical server configured to execute inspection management application 205. The one or more remote computing systems (e.g., 100 of FIG. 1) may be any type of computing system that provides web access to the inspection management application 205 through one or more of the web portals (e.g., 220, 225, 230, 235, and 240).

Inspection management application 205 may include one or more databases 210 that store various data associated with inspection management including predetermined information entered by an administrator 250 or management 255, information entered by various users (e.g., 250, 255, 260, 265, and 270), and information and documents generated by the application 205 based on the predetermined information and the information entered by the users (e.g., 250, 255, 260, 265, and 270).

A client 270 may be a customer such as, for example, a contractor, requesting one or more inspection services from an inspection company (not independently illustrated). Database 210 may include various client 270 information including, but not limited to, name, mailing address, billing address, contact information, email address, telephone number, tax information, preferences, billing status, historical data, and other pertinent information. This information may be entered into the database 210 by the administrator 250 or other authorized user (e.g., 255, 260, or 265) of the inspection management system 200 or the client 270 depending on the information and the allocation of rights by the administrator 250. The administrator 250 of inspection management system 200 may control the rights, including read, write, or modify access, that the client 270 may have for various data in database 210 of inspection management application 205 in accordance with the administrator 250 or other authorized user's (e.g., 255, 260, or 265) wishes. In certain embodiments, any one or more of the above-noted duties performed by the administrator 250 may be performed by an authorized user such as, for example, management 255, finance 260, or an inspector 265, depending on the allocation of rights and privileges.

An inspector 265 may be the person who performs inspection services for one or more clients 270 on behalf of the inspection company (not independently illustrated). Database 210 may include various inspector 265 information including, but not limited to, name, mailing address, billing address, contact information, email address, telephone number, crew information, region served, inspection equipment the inspector is in possession of, the calibration status of that equipment, calibration documents for that equipment, current location of the inspector, crew, and equipment, historical data, and other pertinent information. This information may be entered into the database 210 by the administrator 250 or other authorized user (e.g., 255 or 260) of the inspection management system 200 or the inspector 265 depending on the information and the allocation of rights by the administrator 250. The administrator 250 of the inspection management system 200 may control the rights, including read, write, or modify access, that the inspector 265 may have for various data in database 210 of inspection management application 205 in accordance with the administrator 250 or other authorized user's (e.g., 255 or 260) wishes. In certain embodiments, one or more of the above-noted duties performed by the administrator 250 may be performed by an authorized user such as, for example, management 255, finance 260, or an inspector 265, depending on the allocation of rights and privileges.

The inspection company (not independently illustrated) may populate the database with predetermined information that includes common inspection services offered. As such, database 210 may include a list of inspection services that are offered, the inspection equipment required to perform the services, job safety analysis information that includes safety suggestions for performing the services, potential hazards, recommendations to reduce or eliminate potential hazards, pricing information, and other pertinent information. This information may be entered into the database 210 by the administrator 250 or other authorized user (e.g., 255, 260, or 265) of the inspection management system 200. The administrator 250 of the inspection management system 200 may control the rights, including read, write, or modify access, that the user (e.g., 255, 260, 265, or 270) may have for various data in database 210 of inspection management application 205 in accordance with the administrator 250 or other authorized user's (e.g., 255, 260, or 265) wishes. In certain embodiments, one or more of the above-noted duties performed by the administrator 250 may be performed by an authorized user such as, for example, management 255, finance 260, or an inspector 265, depending on the allocation of rights and privileges.

Once an inspection is performed, the inspector 265 may enter into database 210 detailed job information including, but not limited to, safety observations, measurement data, photographs, videos, inspection reports, historical data, and other pertinent information relating to the results of the inspection services performed. The administrator 250 of the inspection management system 200 may control the rights, including read, write, or modify access, that the users (e.g., 255, 260, 265, or 270) may have for various data in database 210 of inspection management application 205 in accordance with the administrator 250 or other authorized user's (e.g., 255, 260, or 265) wishes. For example, clients 270 may have read-only access to safety observations, measurement data, inspection reports, photographs, videos, and other data or documents so as to preserve their integrity. Notwithstanding the above, database 210 may include other data, information, and documents provided by any user, including clients 270, which they may wish to associate with a particular inspection job and retain for posterity. In certain embodiments, one or more of the above-noted duties performed by the administrator 250 may be performed by an authorized user such as, for example, management 255, finance 260, an inspector 265, or client 270, depending on the allocation of rights and privileges.

From a finance perspective, when a client 270 requests a quotation for inspection services through client portal 240 of inspection management application 205, inspection management application 205 may generate a quotation based on initial job information provided by the client 270 and predetermined information stored in the database 210. The initial job information may include client information, the type of inspection services requested, the location where the inspection services are to be performed, on-site contact information, scheduling information, and other pertinent information. The predetermined information may include a price list for various inspection services that the inspection company (not independently illustrated) has previously provided, discounts extended to certain clients, inspectors available, inspection crew information, region served, inspection equipment the inspectors are in possession of, the calibration status of that equipment, calibration documents for that equipment, current location of the inspector, crew, and equipment, and other pertinent information. In certain embodiments, inspection management application 205 may prepare the quotation based on the initial job information and predetermined information only. In other embodiments, inspection management application 205 may prepare a draft quotation based on the initial job information and predetermined information and any changes made by an authorized user (e.g., 250, 255, 260, 265, or 270). Once the quotation is prepared, the client 270 may be provided with access to the quotation via their web portal 240 and the quotation may be stored in database 210.

Upon completion of inspection services, inspection management application 205 may generate a billing authorization (not shown) based on the quotation, and any authorized changes to the quotation (not shown), from information stored in database 210. In certain embodiments, inspection management application 205 may prepare the billing authorization (not shown) based on information taken from one or more of initial job information, predetermined information, detailed job information, and other information stored in database 210, including, for example, a previously approved quotation (not shown). Once the client 270 approves of the billing authorization (not shown), by click or electronic signature, the approved billing authorization may be stored in database 210 with access provided to authorized users (e.g., 250, 255, 260, 265, or 270).

Inspection management application 205 may include an optional interface 215 to one or more external software applications 245. This interface 215 may, for example, facilitate the exchange of financial information, technical information, or reporting information with an external software application 245. In certain embodiments, interface 215 may facilitate the transfer of financial information such as, for example, quotation or billing authorization information, to an accounting software application (not shown) maintained by, for example, the inspection company (not shown) or maybe even a client 270. In other embodiments, interface 215 may facilitate the transfer of data or information relating to inspection services to a spreadsheet software application (not shown) used by a user (e.g., 250, 255, 260, 265, or 270). In still other embodiments, interface 215 may facilitate the transfer of data or information relating to inspection services to a reporting software application (not shown) used to generate user-defined reports requested by a user (e.g., 245, 250, 255, 260, 265, or 270).

Inspection management application 205 may include a plurality of customizable portals (e.g., 220, 225, 230, 235, and 240) that may be configured for the particular use of the intended end user (e.g., 250, 255, 260, 265, and 270) via web access. While the various portals may vary somewhat in their feature set, one of ordinary skill in the art will recognize that the portals may vary by way of the read, write, or modify access that a particular end user has access to. An administrator portal 220 of inspection management application 205 may, for example, allow an administrator 245 to perform various administrative tasks such as, for example, setting rights and privileges of various users (e.g., 250, 255, 260, 265, or 270), configure preferences, configure features and settings, and other administrative tasks. A management portal 225 of inspection management application 205 may, for example, allow management 255 personnel of the inspection company (not shown) to perform various managerial tasks such as, for example, maintaining client information, inspector information, price lists, quotations, billing authorizations, reporting, and other managerial tasks. A finance portal 230 of inspection management application 205 may, for example, allow finance 260 personnel of the inspection company (not shown) to perform various finance related tasks relating to, for example, quotations, billing authorizations, asset management, reporting, and other finance tasks. An inspector portal 235 of inspection management application 205 may, for example, allow inspectors 265 of the inspection company (not shown) to review information relating to, for example, a quotation, client information, inspection jobs, job safety analysis, initial job information from the request for inspection services, price lists, billing authorizations, and equipment and calibration status of equipment. Inspector 265 may also enter safety observation checklist information, inspection reports, photographs, videos, and other data and documents as needed for an inspection job. A client portal 240 of inspection management application 205 may, for example, allow a client 270 to enter a request for quotation for an inspection job, modify certain client information, review a quotation, approve a quotation, review a billing authorization, approve a billing authorization, and review various job reports including job safety analysis, safety observation checklist information, inspection reports, measurement data, photographs, videos, and other data and information related to inspection services for an inspection job. One of ordinary skill in the art will recognize that the content and access provided by the various web portals may vary based on an application or design in accordance with one or more embodiments of the present invention.

As such, inspection management system 200 includes an inspection management application 205 that is configured to execute on a server and provide remote access to various users who may collaboratively exchange pertinent information relating to inspection services, in near real-time, while storing and maintaining the integrity of the related documentation for compliance with safety and regulatory requirements.

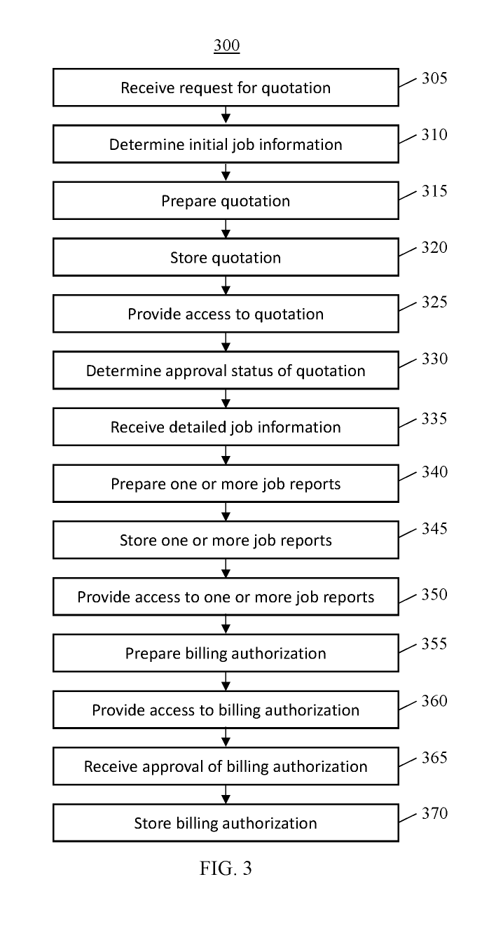

FIG. 3 shows a method 300 of inspection management for energy operations in accordance with one or more embodiments of the present invention. In certain embodiments, the method 300 may be performed by an inspection management application (205 of FIG. 2) configured to execute on a server (e.g., 100 of FIG. 1). In other embodiments, a non-transitory computer readable medium comprising software instructions that, when executed by a processor, may perform the method 300. One of ordinary skill in the art will recognize that the method 300 may be used as part of an inspection management system (200 of FIG. 2) in accordance with one or more embodiments of the present invention.

In step 305, a request for quotation for an inspection job may be received by the inspection management application (205 of FIG. 2). Typically, a client (270 of FIG. 2) will log into the inspection management application (205 of FIG. 2) remotely via a client web portal (240 of FIG. 2) and input a request for quotation, including initial job information. The initial job information may include, but is not limited to, client information, the type of inspection services requested, the location where the inspection services are to be performed, on-site contact information, scheduling information, and any other pertinent information. The request for quotation may be stored in the database (210 of FIG. 2) and assigned a pending status. One of ordinary skill in the art will recognize that other authorized users may input a request for quotation in accordance with one or more embodiments of the present invention.

In step 310, initial job information may be determined by the inspection management application (205 of FIG. 2) from the client request for quotation and predetermined information stored in the database (210 of FIG. 2) of the inspection management application (205 of FIG. 2). The initial job information may include, but is not limited to, client information, the type of inspection services requested, the location where the inspection services are to be performed, on-site contact information, scheduling information, and any other pertinent information. The predetermined information may include, but is not limited to, a quote number, a price list for various inspection services provided, discounts extended to certain clients, inspectors available, inspection crew information, region served, inspection equipment the inspectors are in possession of, the calibration status of that equipment, calibration documents for that equipment, current location of the inspectors, crew, and equipment, and other pertinent information. Inspection management application (205 of FIG. 2) may, for example, determine which inspector, crew, and equipment are available for a particular inspection job requested, the calibration status of the equipment, the type of inspection services requested, and the pricing information for the inspection services requested. In essence, the initial job information includes substantially all information that may be necessary to generate a quotation for an inspection job.

In step 315, a quotation for an inspection job may be prepared. In certain embodiments, the inspection management application (205 of FIG. 2) may prepare the quotation based on the initial job information and the predetermined information only. In other embodiments, the inspection management application (205 of FIG. 2) may prepare a draft quotation based on the initial job information and the predetermined information and any changes made by an authorized user (e.g., 250, 255, 260, 265, or 270). For example, the authorized user may change the quoted services, increase or decrease a particular cost, expense, or fee, or add additional cost, expense, or fees that were not comprehended by the original request for quotation.

In step 320, the quotation may be stored in the database (210 of FIG. 2) of the inspection management application (205 of FIG. 2).

In step 325, the client (270 of FIG. 2) may be provided with access to the quotation via the client web portal (240 of FIG. 2) of the inspection management application (205 of FIG. 2). The client (270 of FIG. 2) may have the option of approving, disapproving, or proposing changes to the quotation, which may be received and stored by the inspection management application (205 of FIG. 2). Quotations may be assigned statuses reflecting their status in the conventional quotation process. For example, the quotation status may include pending, submitted, won, lost, and action required. A pending quotation status may mean that some information required to prepare the quotation is missing and further action is required from the client or an authorized user of the inspection company. A submitted quotation status may mean that the quotation has been generated and submitted for client consideration. A won or lost status may indicate client approval or disapproval of a given quotation. An action required status may indicate that some action is required by a user of the inspection company.

In step 330, the inspection management application (205 of FIG. 2) may determine whether the client (270 of FIG. 2) has approved of the quotation for inspection services. If the client (270 of FIG. 2) has not taken any action with respect to the quotation, no further action is taken by the inspection management application (205 of FIG. 2) until the client (270 of FIG. 2) takes action. If the client (270 of FIG. 2) disapproves of the quotation, the quotation may be assigned a status of lost and no further action is taken by the inspection management application (205 of FIG. 2). If the client (270 of FIG. 2) proposes changes to the quotation, the quotation may be modified automatically if the proposed changes are comprehended by information in the database (210 of FIG. 2). Otherwise, an authorized user of the inspection company may be required to modify the quotation manually, should they desire to do so. If the client (270 of FIG. 2) approves of the quotation, the quotation may be assigned a status of won and the inspection management application (205 of FIG. 2) may move the job from the quotation interface to the inspections interface.

At this point, the inspector (265 of FIG. 2) may have access to a job safety analysis report, prepared by the inspection management application (205 of FIG. 2). Based on the information related to the inspection services to be performed as part of the inspection job, the inspection management application (205 of FIG. 2) may prepare a job safety analysis report that identifies the safety equipment required to perform the inspection services, a sequence of basic steps to perform in performing the inspection services, potential hazards or accidents associated with each and every step, and recommendations to reduce or eliminate hazards or accidents associated with each and every step. This job safety analysis report may be stored in the database (210 of FIG. 2) of inspection management application (205 of FIG. 2). One of ordinary skill in the art will recognize that the job safety analysis report may include any other information relevant to safety in accordance with one or more embodiments of the present invention.

In step 335, the inspection management application (205 of FIG. 2) may receive detailed job information from the inspector that may be stored in the database (210 of FIG. 2). Upon approval of the quotation, the inspection job may be treated as an inspection in progress. The inspector (265 of FIG. 2) may travel to the inspection site, perform the required inspection services, take and log measurement data, take and log photographs, record and log video, or take any other actions, including documentary actions, to complete the inspection job. While on-site, or shortly thereafter, the inspector may also complete and log a safety observation checklist provided by the inspection management application (205 of FIG. 2).

In step 340, the inspection management application (205 of FIG. 2) may prepare one or more job reports related to the inspection job. The one or more job reports may include, but are not limited to, a safety observation checklist, an inspection report, inspection photographs, inspection videos, customer documents, historical data, and other pertinent information relating to the inspection job. The safety observation checklist may include, but is not limited to, information relating to the status, safety, and concerns regarding one or more of personnel protective equipment, tools, equipment, work conditions, housekeeping, body position, body mechanics, procedures, operations, vehicles, mobile equipment, driving, water, shade, and any other safety consideration. The inspector (265 of FIG. 2) may fill out the safety observation checklist in the inspection management application (205 of FIG. 2) through the inspector portal (235 of FIG. 2) accessed through a web interface of a computing system (e.g., 100 of FIG. 1) while on-site or shortly after performing the inspection services.

The inspection report may include, but is not limited to, the type of equipment inspected, its serial number or other identifying information, relevant dimensions, measurement data, historical data, and any other relevant acceptance or rejection criteria. One of ordinary skill in the art will recognize that the acceptance or rejection criteria may vary based on the type or kind of equipment. The inspector (265 of FIG. 2) may enter various measurement data, including his judgement as to whether to accept or reject a particular piece of equipment, in the inspection management application (205 of FIG. 2) through the inspector portal (235 of FIG. 2) accessed through a web interface of a computing system (e.g., 100 of FIG. 1) while on-site or shortly after performing the inspection services. In addition, a report containing inspection photographs may be generated that may include photographs of the tools, equipment, or systems that are the subject of inspection that the inspector (265 of FIG. 2) uploaded into the inspection management application (205 of FIG. 2). Similarly, a report containing inspection videos may be generated that includes snapshots of videos, or links to actual video clips, of the tools, equipment, or systems that are the subject of inspection that the inspector (265 of FIG. 2) uploaded into the inspection management application (205 of FIG. 2).

In step 345, the one or more job reports related to the inspection job may be stored in the database (210 of FIG. 2) of the inspection management application (205 of FIG. 2).

In step 350, the inspection management application (205 of FIG. 2) may provide access to the one or more job reports to an authorized user (e.g., 250, 255, 260, 265, or 270) through one or more of the portals (e.g., 220, 225, 230, 235, and 240) according to the rights and privileges assigned by the administrator (250 of FIG. 2) or authorized user (e.g., 250, 255, 260, or 265) of the inspection company.

In step 355, a billing authorization for the inspection job may be prepared by the inspection management application (205 of FIG. 2). In certain embodiments, the inspection management application (205 of FIG. 2) may use information from the quotation and the database (210 of FIG. 2) to generate a billing authorization for the client's (270 of FIG. 2) approval. The information included in the billing authorization may include the client name, client job number, client contact, rig, quote, purchase order, inspection services performed, price of inspection services performed, any discounts applied, and a total amount due for the job. In some embodiments, the inspection management application (205 of FIG. 2) may use information from the quotation and the database (210 of FIG. 2) to generate a draft billing authorization for review by an authorized user (e.g., 250, 255, 260, or 265) of the inspection company. Upon review and approval by the authorized user (e.g., 250, 255, 260, or 265), the billing authorization may be provided for the client's (270 of FIG. 2) approval.

In step 360, access to the billing authorization may be provided to the client (270 of FIG. 2) through the client portal (240 of FIG. 2) of the inspection management application (205 of FIG. 2).

In step 365, the client (270 of FIG. 2) may approve the billing authorization through the client portal (240 of FIG. 2) of the inspection management application (205 of FIG. 2). In certain embodiments, the client (270 of FIG. 2) may provide their approval by clicking an approval button or signing electronically within the portal (240 of FIG. 2) interface.

In step 370, the approved billing authorization may be stored in the database (210 of FIG. 2) of inspection management application (205 of FIG. 2).

Inspection management application (205 of FIG. 2) may also provide linkage to one or more external software applications to facilitate the exchange of financial information, technical information, or reporting information. In certain embodiments, linkage may be provided to facilitate the transfer of financial information such as, for example, quotation or billing authorization information, to an accounting software application (not shown) maintained by, for example, the inspection company (not shown) or maybe even a client (270 of FIG. 2). In other embodiments, linkage may be provided to facilitate the transfer of data or information relating to inspection services to a spreadsheet software application (not shown) used by a user (e.g., 250, 255, 260, 265, or 270). In still other embodiments, linkage may be provided to facilitate the transfer of data or information relating to inspection services to a reporting software application (not shown) used to generate user-defined reports requested by a user (e.g., 250, 255, 260, 265, or 270).

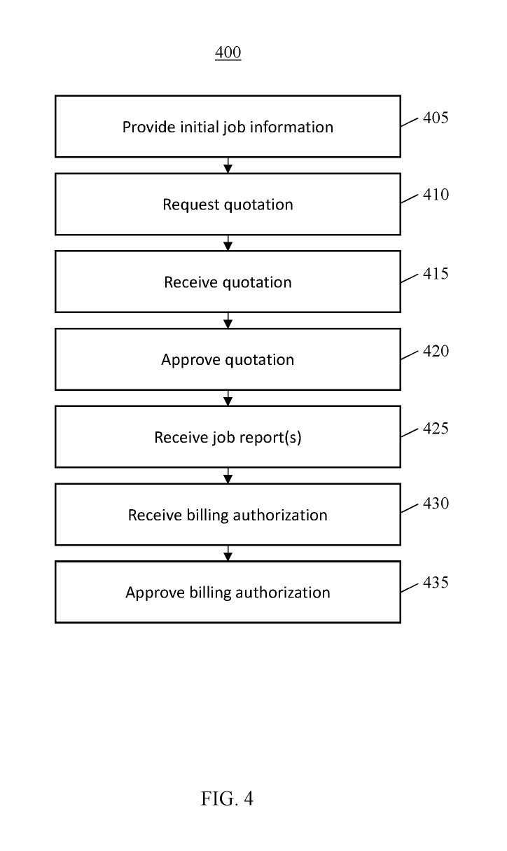

FIG. 4 shows a method 400 of client (270 of FIG. 2) interaction with an inspection management system (200 of FIG. 2) for energy operations in accordance with one or more embodiments of the present invention. One or more clients (270 of FIG. 2) may interact with the inspection management application (205 of FIG. 2) through a client web portal (240 of FIG. 2) remotely accessed from a web interface of their respective computing systems (e.g., 100 of FIG. 1). The client (270 of FIG. 2) may request a quotation, review the status of pending quotations, review the status of any inspections in progress, review job reports including job safety analysis, safety observation checklists, inspection reports, inspection photographs, inspection videos, historical data, and other documents related to inspections already completed, review billing authorizations, or search the database (210 of FIG. 2) for any pertinent information that they are authorized to view.

In step 405, a client (270 of FIG. 2) may provide initial job information to the inspection management application (205 of FIG. 2) through the client web portal (240 of FIG. 2) remotely accessed from a web interface of their computing system (e.g., 100 of FIG. 1). The initial job information may include client information, the type of inspection services requested, the location where the inspection services are to be performed, on-site contact information, scheduling information, and other pertinent information.

In step 410, the client (270 of FIG. 2) may request a quotation for an inspection job from the inspection management application (205 of FIG. 2). The request may be tendered through the client web portal (240 of FIG. 2) to the inspection management application (205 of FIG. 2).

In step 415, the client (270 of FIG. 2) may receive the quotation prepared and provided by the inspection management application (205 of FIG. 2).

In step 420, the client (270 of FIG. 2) may approve, disapprove, or request modification to the quotation. Within the inspection management application (205 of FIG. 2) the quotation status may include pending, submitted, won, lost, and action required. A pending quotation status may mean that some information required to prepare the quotation is missing and further action is required from the client or an authorized user of the inspection company. A submitted quotation status may mean that the quotation has been generated and submitted for client consideration. A won or lost status may indicate client approval or disapproval of a given quotation. An action required status may indicate that some action is required by a user of the inspection company, perhaps in response to a client request to modify the quotation.

In step 425, upon client (270 of FIG. 2) approval of the quotation, and performance of the inspection services by the inspector (265 of FIG. 2), the client (270 of FIG. 2) may review and receive the one or more job reports prepared by the inspection management application (205 of FIG. 2).

In step 430, the client (270 of FIG. 2) may receive the billing authorization for the inspection job from the inspection management application (205 of FIG. 2).

In step 435, the client (270 of FIG. 2) may approve, disapprove, or request modification to the billing authorization. In the event the client approves of the billing authorization, the client may provide their approval by clicking an approval button or signing electronically within the portal (240 of FIG. 2) interface.

In addition, a client (270 of FIG. 2) may search, sort, and view any pertinent information stored within the database (210 of FIG. 2) of the inspection management application (205 of FIG. 2) that they are authorized to view. However, the client's (270 of FIG. 2) rights and privileges may be dictated by an administrator (250 of FIG. 2) or authorized user (e.g., 255, 260, or 265) of the inspection company.

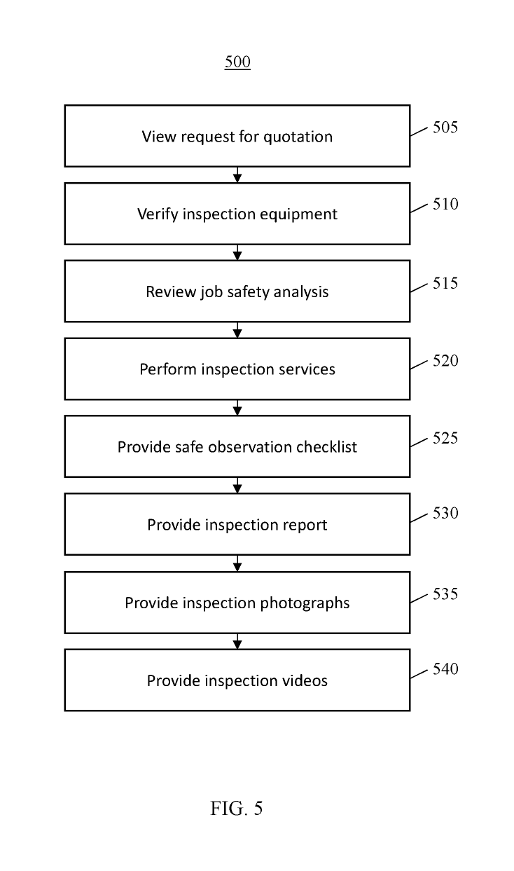

FIG. 5 shows a method 500 of inspector (265 of FIG. 2) interaction with an inspection management system (200 of FIG. 2) for energy operations in accordance with one or more embodiments of the present invention. One or more inspectors (265 of FIG. 2) may interact with the inspection management application (205 of FIG. 2) through an inspector portal (235 of FIG. 2) remotely accessed from a web interface of their respective computing systems (e.g., 100 of FIG. 1). The inspector (265 of FIG. 2) may review or modify requests for quotation, inspection equipment, calibration status, job safety analysis, and billing authorizations and input safety observation checklists, inspection reports, photographs, videos, and other documentation, or search the database (210 of FIG. 2) for any pertinent information that they are authorized to view.

In step 505, an inspector (265 of FIG. 2) may view or modify a request for quotation in the inspection management application (205 of FIG. 2) through the inspector portal (235 of FIG. 2) remotely accessed from a web interface of a computing system (e.g., 100 of FIG. 1).

In step 510, the inspector (265 of FIG. 2) may view, modify, or verify inspection equipment they are in possession of as well as the calibration status of the equipment. Depending on the request for inspection services, part of the verification of inspection equipment may include verifying that they are in possession of the requisite equipment to perform the requested inspection services and that the equipment is demonstratively calibrated.

In step 515, the inspector (265 of FIG. 2) may review a job safety analysis report that is provided by the inspection management application (205 of FIG. 2) for the particular inspection services to be performed. The job safety analysis report that may identify the safety equipment required to perform the inspection services, a sequence of basic steps to perform in performing the inspection services, potential hazards or accidents associated with each and every step, and recommendations to reduce or eliminate hazards or accidents associated with each and every step.

In step 520, the inspector (265 of FIG. 2) may perform the inspection services as part of the inspection job.

In step 525, the inspector (265 of FIG. 2) may input a safety observation checklist into the inspection management application (205 of FIG. 2). The safety observation checklist may include, but is not limited to, information relating to the status, safety, and concerns regarding one or more of personnel protective equipment, tools, equipment, work conditions, housekeeping, body position, body mechanics, procedures, operations, vehicles, mobile equipment, driving, water, shade, and any other safety consideration. The inspector (265 of FIG. 2) may fill out the safety observation checklist in the inspection management application (205 of FIG. 2) through the inspector portal (235 of FIG. 2) accessed through a web interface of a computing system (e.g., 100 of FIG. 1) while on-site or shortly after performing the inspection services.

In step 530, the inspector (265 of FIG. 2) may input an inspection report into the inspection management application (205 of FIG. 2). The inspection report may include, but is not limited to, the type of equipment inspected, its serial number or other identifying information, relevant dimensions, measurement data, and any other relevant acceptance or rejection criteria.

In step 535, the inspector (265 of FIG. 2) may input one or more inspection photographs of the tools, equipment, or systems that are the subject of inspection into the inspection management application (205 of FIG. 2).

In step 540, the inspector (265 of FIG. 2) may input one or more videos of the tools, equipment, or systems that are the subject of inspection into the inspection management application (205 of FIG. 2).

In one or more embodiments of the present invention, an inspection management application (205 of FIG. 2) of an inspection management system (200 of FIG. 2) may reside and execute from a server (e.g., 100 of FIG. 1). The various users of the inspection management system (200 of FIG. 2), including, for example, administrators (250 of FIG. 2), management representatives (255 of FIG. 2), finance representatives (260 of FIG. 2), inspectors (265 of FIG. 2), and clients (270 of FIG. 2) may access the inspection management application (205 of FIG. 2) through various portals (e.g., 220, 225, 230, 235, and 240) that are remotely accessed from web interfaces of their respective computing systems (e.g., 100 of FIG. 1). The portals (e.g., 220, 225, 230, 235, and 240) may vary in design or simply limit access based on the rights and privileges of the particular type of user.

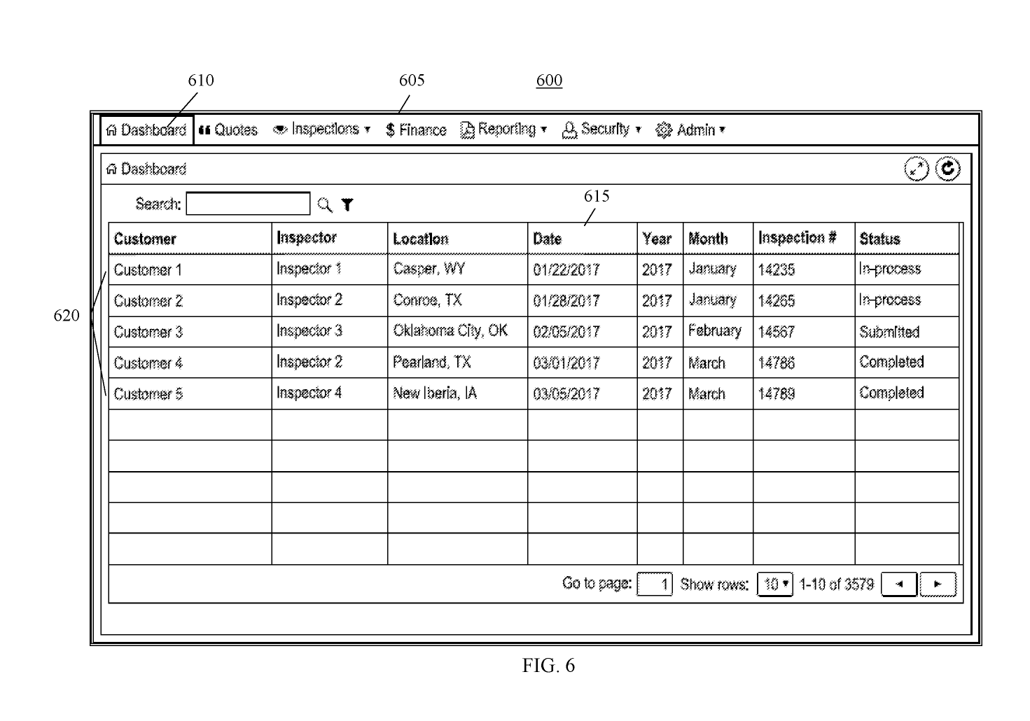

In the FIGS. 6 through 14, example user-interfaces (e.g., 600, 700, 800, 900, 1000, 1100, 1200, 1300, and 1400) that are presented to users (250, 255, 260, 265, and 270) through their respective portals (e.g., 220, 225, 230, 235, and 240) of inspection management application (200 of FIG. 2) are shown in accordance with one or more embodiments of the present invention. One of ordinary skill in the art will recognize that the user-interfaces may vary based on an application or design and the examples shown are merely exemplary. In addition, one of ordinary skill in the art will recognize that the user-interfaces may vary based on rights and privileges of respective users.

FIG. 6 shows a dashboard user-interface 600 of an inspection management system (200 of FIG. 2) for energy operations in accordance with or more embodiments of the present invention. User-interface 600 may include a menu bar 605 that exposes the user to a dashboard, quotations, inspections, finance, reporting, security, or admin sub-menu options. In the user-interface 600 shown, the dashboard sub-menu 610 option is selected and the dashboard view 615 is displayed. The dashboard view 615 may include a plurality of entries 620 showing various inspection job related activities that are in process. Each entry 620 in the dashboard view 615 may include job identifying information, customer identifying information, inspector information, location, date, status information, and any other pertinent information. Each entry 620 may be clickable to pull up detailed information regarding that particular entry 620. One of ordinary skill in the art will recognize that the dashboard view 615 may vary based on an application or design and may vary in the information presented depending on the rights and privileges of the respective user. Similarly, one of ordinary skill in the art will recognize that the information presented in each entry 620 may vary based on an application or design and may vary in the information presented depending on the rights and privileges of the respective user.

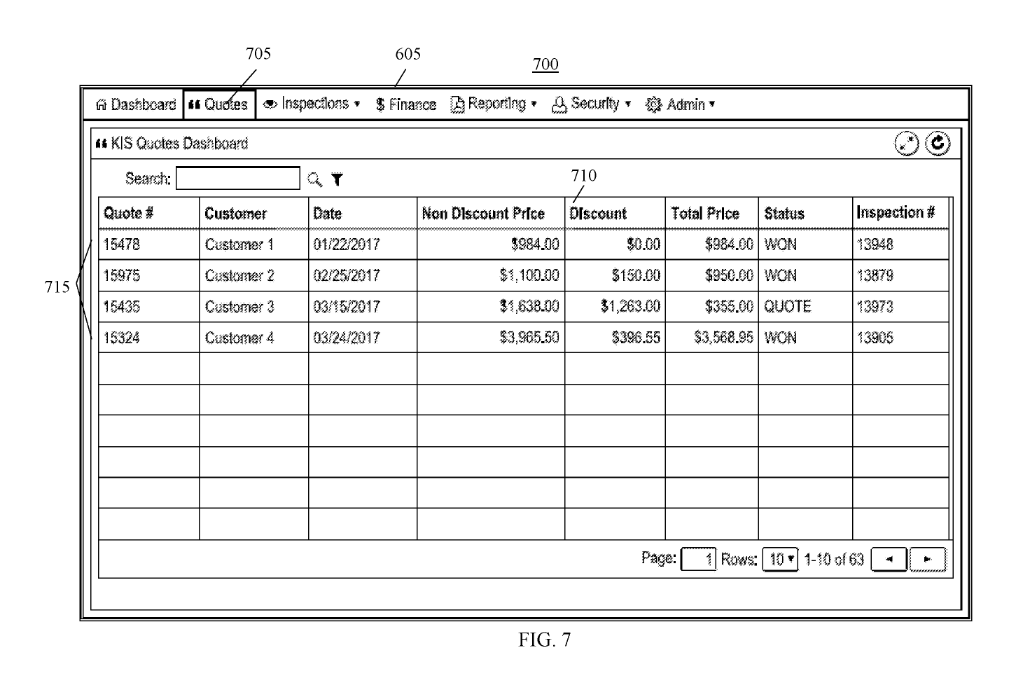

FIG. 7 shows a quotations user-interface 700 of an inspection management system (200 of FIG. 2) for energy operations in accordance with or more embodiments of the present invention. User-interface 700 may include a menu bar 605 that exposes the user to a dashboard, quotations, inspections, finance, reporting, security, or admin sub-menu options. In the user-interface 700 shown, the quotations sub-menu 705 option is selected and the quotations view 710 is displayed. The quotations view 710 may include a plurality of entries 715 showing various quotations that are in process. Each entry 715 in the quotations view 710 may include job identifying information, customer identifying information, inspector information, location, date, non-discounted price, discounts, extended price, status information, and any other pertinent information. Each entry 715 may be clickable to pull up detailed information regarding that particular entry 715. One of ordinary skill in the art will recognize that the quotations view 710 may vary based on an application or design and may vary in the information presented depending on the rights and privileges of the respective user. Similarly, one of ordinary skill in the art will recognize that the information presented in each entry 715 may vary based on an application or design and may vary in the information presented depending on the rights and privileges of the respective user.

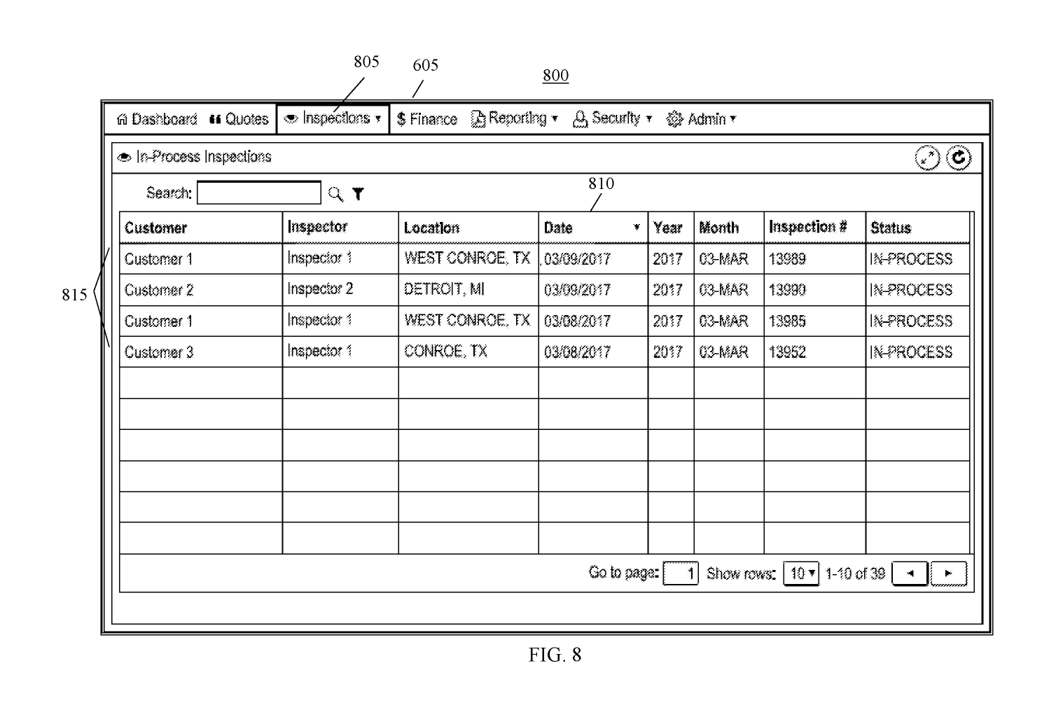

FIG. 8 shows an inspections user-interface 800 of an inspection management system (200 of FIG. 2) for energy operations in accordance with or more embodiments of the present invention. User-interface 800 may include a menu bar 605 that exposes the user to a dashboard, quotations, inspections, finance, reporting, security, or admin sub-menu options. In the user-interface 800 shown, the inspections sub-menu 805 option is selected and the inspections view 810 is displayed. The inspections view 810 may include a plurality of entries 815 showing various inspection jobs that are in process. Each entry 815 in the inspections view 810 may include job identifying information, customer identifying information, inspector information, location, date, status information, and any other pertinent information. Each entry 815 may be clickable to pull up detailed information regarding that particular entry 815. One of ordinary skill in the art will recognize that the inspections view 810 may vary based on an application or design and may vary in the information presented depending on the rights and privileges of the respective user. Similarly, one of ordinary skill in the art will recognize that the information presented in each entry 815 may vary based on an application or design and may vary in the information presented depending on the rights and privileges of the respective user.

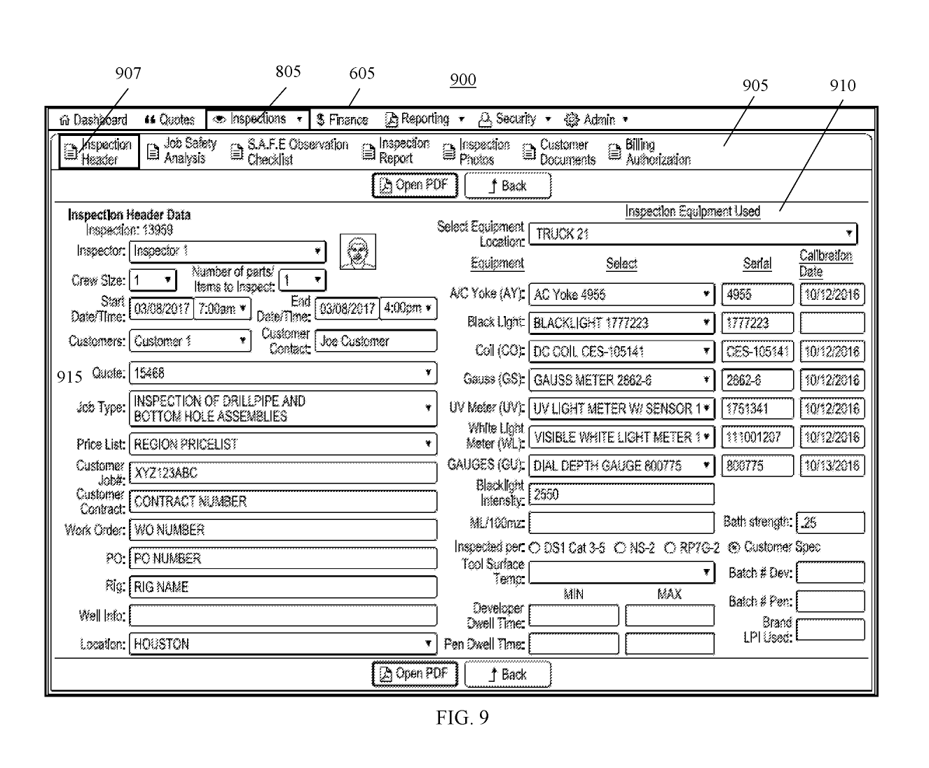

FIG. 9 shows an inspection header user-interface 900 of an inspection management system (200 of FIG. 2) for energy operations in accordance with or more embodiments of the present invention. User-interface 900 may include a menu bar 605 that exposes the user to a dashboard, quotations, inspections, finance, reporting, security, or admin sub-menu options. In the user-interface 900 shown, the inspections sub-menu 805 option was selected, and a user clicked on a particular inspection job, or entry, (815 of FIG. 8) from the inspections view (810 of FIG. 8) such that an inspection job sub-menu bar 905 is shown. The inspection job sub-menu bar 905 exposes the user to inspection header, job safety analysis, safety observation checklist, inspection report, inspection photos, customer documents, and billing authorization sub-menu options.

In the user-interface 900 shown, the user has clicked on the inspection header 907 sub-menu option from the sub-menu bar 905, displaying inspection header data 910 for the selected inspection job. The inspection header data 910 may include a plurality of entries 915 showing information relating to the inspector assigned for the inspection job. The entries 915 may include information including, but not limited to, job identifying information, customer identifying information, inspector information, location, date, status information, inspection equipment information, inspection equipment location information, inspection equipment calibration status information, and any other pertinent information. Some entries 915 may be clickable to pull up detailed information regarding that particular entry 915, such as, for example, a calibration entry may be clickable to bring up a detailed calibration report. One of ordinary skill in the art will recognize that the inspection header data 910 may vary based on an application or design and may vary in the information presented depending on the rights and privileges of the respective user. Similarly, one of ordinary skill in the art will recognize that the information presented in each entry 915 may vary based on an application or design and may vary in the information presented depending on the rights and privileges of the respective user.

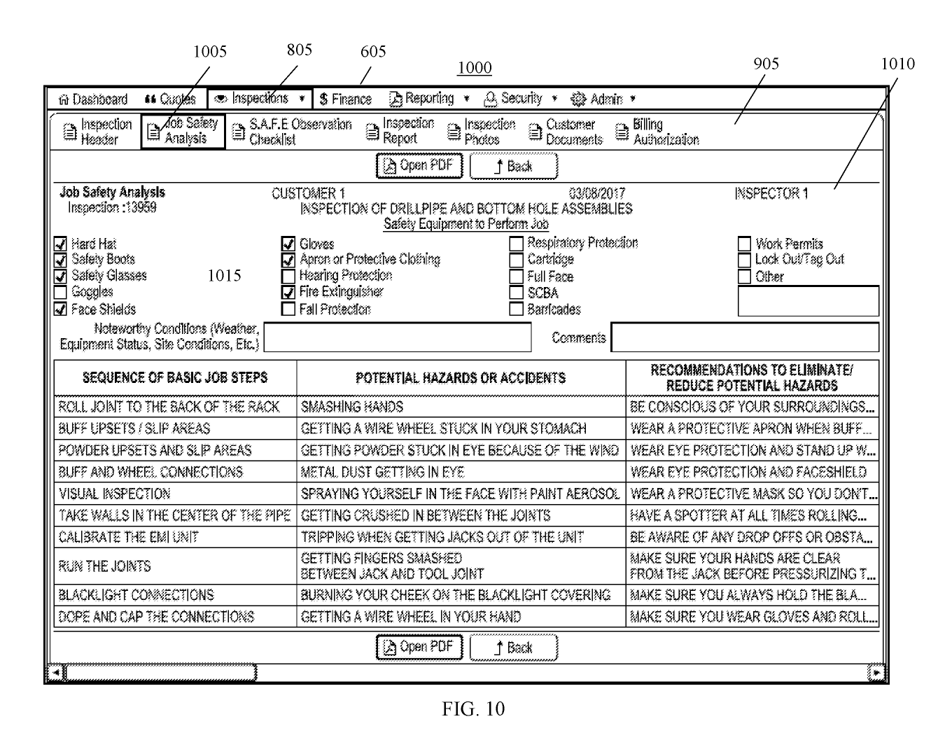

FIG. 10 shows a job safety analysis user-interface 1000 of an inspection management system (200 of FIG. 2) for energy operations in accordance with or more embodiments of the present invention. User-interface 1000 may include a menu bar 605 that exposes the user to a dashboard, quotations, inspections, finance, reporting, security, or admin sub-menu options. In the user-interface 1000 shown, the inspections sub-menu 805 option was selected, and a user clicked on a particular inspection job, or entry, (815 of FIG. 8) from the inspections view (810 of FIG. 8) such that an inspection job sub-menu bar 905 is shown. The inspection job sub-menu bar 905 exposes the user to inspection header, job safety analysis, safety observation checklist, inspection report, inspection photos, customer documents, and billing authorization sub-menu options.

In the user-interface 1000 shown, the user has clicked on the job safety analysis 1005 sub-menu option from the sub-menu bar 905, displaying job safety data 1010 for the selected inspection job. The job safety data 1010 may include a plurality of entries 1015 showing information relating to job safety that will assist the inspector (265 of FIG. 2) in performing the inspection services in a safe and compliant manner. The entries 1015 may include information such as, for example, safety suggestions for performing the services, potential hazards, recommendations to reduce or eliminate potential hazards, job identifying information, customer identifying information, inspector information, location, date, status information, inspection equipment information, inspection equipment location information, inspection equipment calibration status information, and any other pertinent information. Some entries 1015 may be clickable to pull up detailed information regarding that particular entry 1015, such as, for example, a process step may be clickable to launch a video or tutorial showing how to perform the process step. One of ordinary skill in the art will recognize that the job safety data 1010 may vary based on an application or design and may vary in the information presented depending on the rights and privileges of the respective user. Similarly, one of ordinary skill in the art will recognize that the information presented in each entry 1015 may vary based on an application or design and may vary in the information presented depending on the rights and privileges of the respective user.

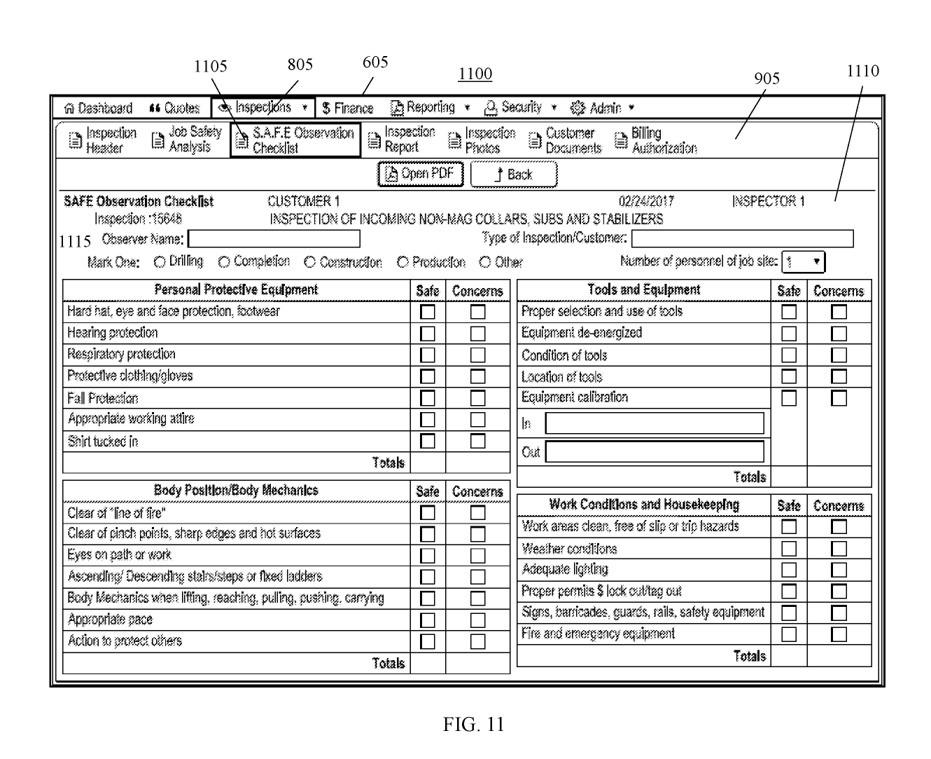

FIG. 11 shows a safety observation checklist user-interface 1100 of an inspection management system (200 of FIG. 2) for energy operations in accordance with or more embodiments of the present invention. User-interface 1100 may include a menu bar 605 that exposes the user to a dashboard, quotations, inspections, finance, reporting, security, or admin sub-menu options. In the user-interface 1100 shown, the inspections sub-menu 805 option was selected, and a user clicked on a particular inspection job, or entry, (815 of FIG. 8) from the inspections view (810 of FIG. 8) such that an inspection job sub-menu bar 905 is shown. The inspection job sub-menu bar 905 exposes the user to inspection header, job safety analysis, safety observation checklist, inspection report, inspection photos, customer documents, and billing authorization sub-menu options.

In the user-interface 1100 shown, the user has clicked on the safety observation checklist 1105 sub-menu option from the sub-menu bar 905, displaying safety observation checklist data 1110 for the selected inspection job. The safety observation checklist data 1110 may include a plurality of entries 1115 showing a checklist where the inspector may enter observations regarding the inspection services performed. The entries 1115 may include, but are not limited to, information relating to the status, safety, and concerns regarding one or more of personnel protective equipment, tools, equipment, work conditions, housekeeping, body position, body mechanics, procedures, operations, vehicles, mobile equipment, driving, water, shade, and any other safety consideration. The inspector (265 of FIG. 2) may fill out the safety observation checklist while on-site or shortly after performing the inspection services. Some entries 1115 may be clickable to pull up detailed information regarding that particular entry 1115. One of ordinary skill in the art will recognize that the safety observation checklist data 1110 may vary based on an application or design and may vary in the information presented depending on the rights and privileges of the respective user. Similarly, one of ordinary skill in the art will recognize that the information presented in each entry 1115 may vary based on an application or design and may vary in the information presented depending on the rights and privileges of the respective user.

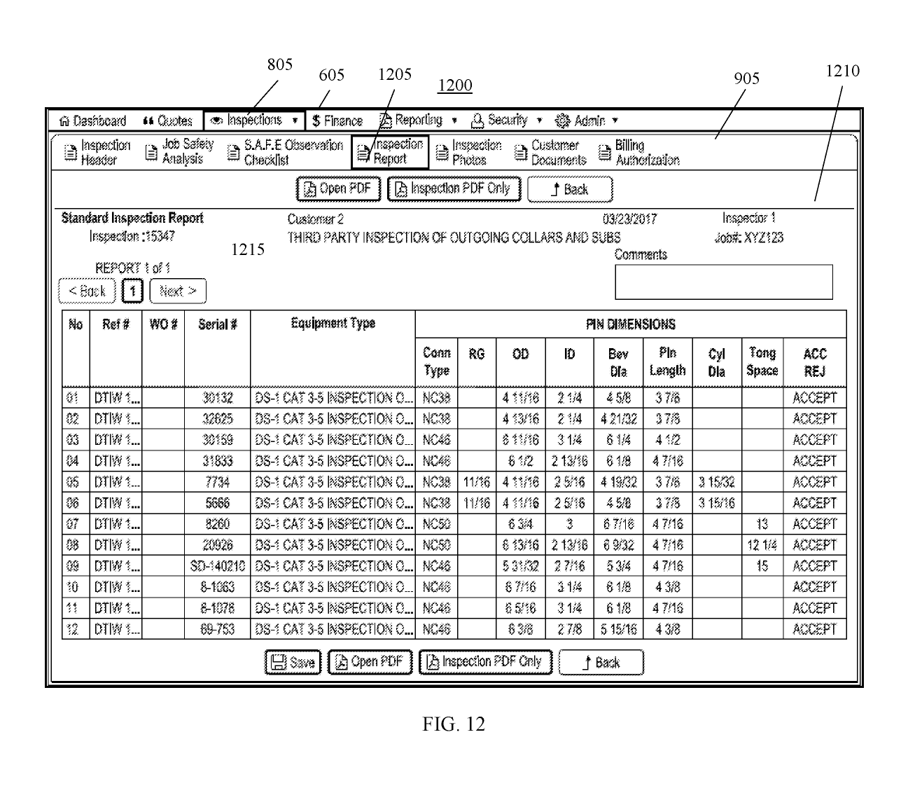

FIG. 12 shows an inspection report user-interface 1200 of an inspection management system (200 of FIG. 2) for energy operations in accordance with or more embodiments of the present invention. User-interface 1200 may include a menu bar 605 that exposes the user to a dashboard, quotations, inspections, finance, reporting, security, or admin sub-menu options. In the user-interface 1200 shown, the inspections sub-menu 805 option was selected, and a user clicked on a particular inspection job, or entry, (815 of FIG. 8) from the inspections view (810 of FIG. 8) such that an inspection job sub-menu bar 905 is shown. The inspection job sub-menu bar 905 exposes the user to inspection header, job safety analysis, safety observation checklist, inspection report, inspection photos, customer documents, and billing authorization sub-menu options.

In the user-interface 1200 shown, the user has clicked on the inspection report 1205 sub-menu option from the sub-menu bar 905, displaying inspection report data 1210 for the selected inspection job. The inspection report data 1210 may include a plurality of entries 1215 showing relevant inspection data related to the inspection services performed as part of the inspection job. The entries 1215 may include, but are not limited to, the type of equipment inspected, its serial number or other identifying information, relevant dimensions, measurement data, historical data, and any other relevant acceptance or rejection criteria. One of ordinary skill in the art will recognize that the acceptance or rejection criteria may vary based on the type or kind of equipment. The inspector (265 of FIG. 2) may input inspection report data 1210 including measurement data and a judgement as to whether to accept or reject a particular piece of equipment while on-site or shortly after performing the inspection services. Some entries 1215 may be clickable to pull up detailed information regarding that particular entry 1215. One of ordinary skill in the art will recognize that the inspection report data 1210 may vary based on an application or design and may vary in the information presented depending on the rights and privileges of the respective user. Similarly, one of ordinary skill in the art will recognize that the information presented in each entry 1215 may vary based on an application or design and may vary in the information presented depending on the rights and privileges of the respective user.

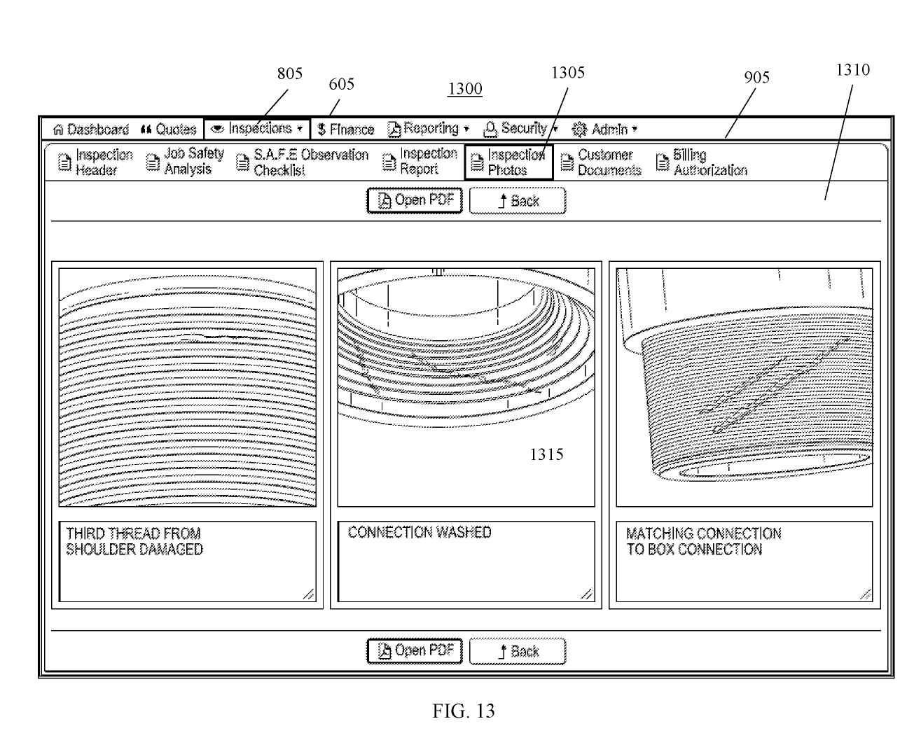

FIG. 13 shows an inspection photos user-interface 1300 of an inspection management system (200 of FIG. 2) for energy operations in accordance with or more embodiments of the present invention. User-interface 1300 may include a menu bar 605 that exposes the user to a dashboard, quotations, inspections, finance, reporting, security, or admin sub-menu options. In the user-interface 1300 shown, the inspections sub-menu 805 option was selected, and a user clicked on a particular inspection job, or entry, (815 of FIG. 8) from the inspections view (810 of FIG. 8) such that an inspection job sub-menu bar 905 is shown. The inspection job sub-menu bar 905 exposes the user to inspection header, job safety analysis, safety observation checklist, inspection report, inspection photos, customer documents, and billing authorization sub-menu options.

In the user-interface 1300 shown, the user has clicked on the inspection photos 1305 sub-menu option from the sub-menu bar 905, displaying inspection photograph data 1310 for the selected inspection job. The inspection photograph data 1310 may include photographs or videos related to the inspection services performed as part of the inspection job. The entries 1315 may include photographs or videos of the tools, equipment, or systems and their working environment that are the subject of inspection. The inspector (265 of FIG. 2) may input inspection photograph data 1310 while on-site or shortly after performing the inspection services. Some entries 1315, such as those linking to video clips, may be clickable to pull up detailed information regarding that particular entry 1315. One of ordinary skill in the art will recognize that the inspection photograph data 1310 may vary based on an application or design and may vary in the information presented depending on the rights and privileges of the respective user. Similarly, one of ordinary skill in the art will recognize that the information presented in each entry 1315 may vary based on an application or design and may vary in the information presented depending on the rights and privileges of the respective user.

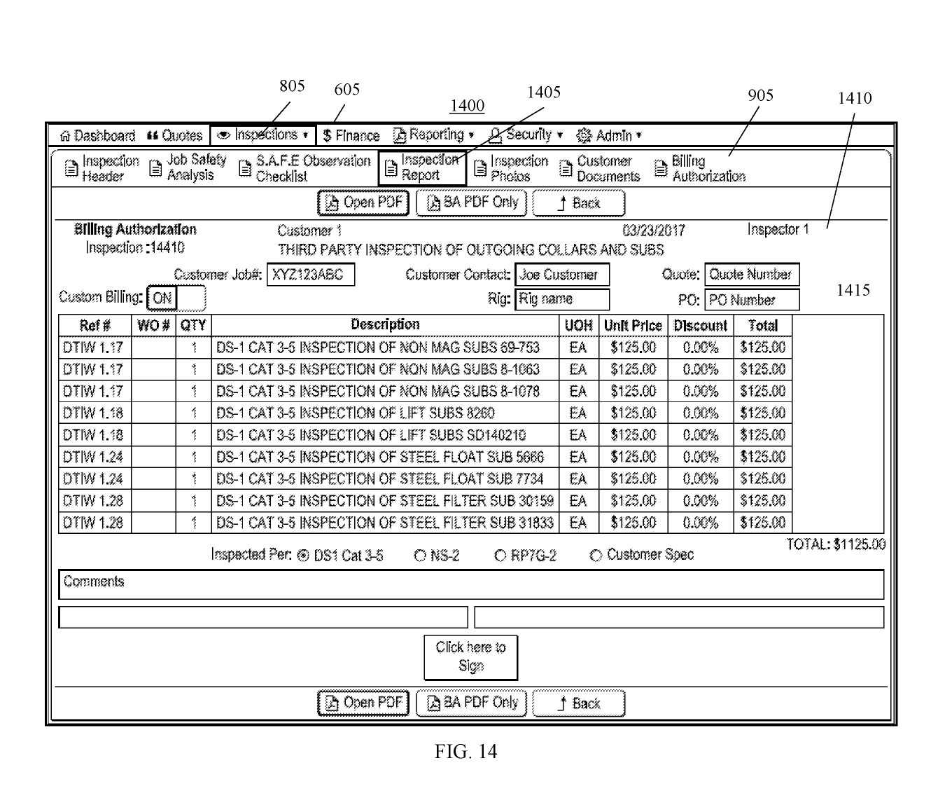

FIG. 14 shows a billing authorization user-interface 1400 of an inspection management system (200 of FIG. 2) for energy operations in accordance with or more embodiments of the present invention. User-interface 1400 may include a menu bar 605 that exposes the user to a dashboard, quotations, inspections, finance, reporting, security, or admin sub-menu options. In the user-interface 1400 shown, the inspections sub-menu 805 option was selected, and a user clicked on a particular inspection job, or entry, (815 of FIG. 8) from the inspections view (810 of FIG. 8) such that an inspection job sub-menu bar 905 is shown. The inspection job sub-menu bar 905 exposes the user to inspection header, job safety analysis, safety observation checklist, inspection report, inspection photos, customer documents, and billing authorization sub-menu options.

In the user-interface 1400 shown, the user has clicked on the billing authorization 1405 sub-menu option from the sub-menu bar 905, displaying billing authorization data 1410 for the selected inspection job. The billing authorization data 1410 may include data needed to prepare and submit a billing authorization for client (270 of FIG. 2) approval. The entries 1415 may include the client name, client job number, client contact, rig, quote, purchase order, inspection services performed, price of inspection services performed, any discounts applied, and a total amount due for the job. Some entries 1415 may be clickable to pull up detailed information regarding that particular entry 1415. One of ordinary skill in the art will recognize that the billing authorization data 1410 may vary based on an application or design and may vary in the information presented depending on the rights and privileges of the respective user. Similarly, one of ordinary skill in the art will recognize that the information presented in each entry 1415 may vary based on an application or design and may vary in the information presented depending on the rights and privileges of the respective user.

Advantages of one or more embodiments of the present invention may include one or more of the following:

In one or more embodiments of the present invention, inspection management for energy operations provides a coherent and comprehensive way to gather, organize, maintain, and provide access to inspection reports for one or more projects.

In one or more embodiments of the present invention, inspection management for energy operations provides a cloud or server based inspection management application that may be remotely accessed through web portals by various stakeholders whose rights and privileges are controlled by the administrator of the inspection management application.

In one or more embodiments of the present invention, inspection management for energy operations allows for the tracking and tracing of equipment and inspection services by integrating quotation approval, inspection services, quality, safety, reporting, documenting, and billing activities within a common database.

In one or more embodiments of the present invention, inspection management for energy operations provides an operator and/or contractor visibility of all inspections performed on their equipment from start to finish of a project. As such, the operator and/or contractor can track and trace all equipment from commission to decommission. Pertinent information related to any piece of equipment, including measurement data, calibration data, photographs, videos, historical data, as well as detailed inspection reports may be maintained and preserved for the lifetime of the project, regulatory review, and posterity.

In one or more embodiments of the present invention, inspection management for energy operations provides an operator and/or contractor the ability to easily search, sort, and gather relevant documents for a given project. Complete job packaging and documentation of all steps and stages of a project may be collated for the operator and/or contractor including contract review, pricing, reporting, documentation, and any accompanying photographs or videos.

In one or more embodiments of the present invention, inspection management for energy operations facilitates operator, contractor, and service provider compliance with API Specification Q1 and Q2.

In one or more embodiments of the present invention, inspection management for energy operations facilitates operator, contractor, and service provider compliance with safety standards.

In one or more embodiments of the present invention, inspection management for energy operations facilitates operator, contractor, and service provider compliance with quality standards.

In one or more embodiments of the present invention, inspection management for energy operations facilitates operator, contractor, and service provider compliance with regulatory standards.

While the present invention has been described with respect to the above-noted embodiments, those skilled in the art, having the benefit of this disclosure, will recognize that other embodiments may be devised that are within the scope of the invention as disclosed herein. Accordingly, the scope of the invention should be limited only by the appended claims.

What is claimed is:

1. A method of inspection management for energy operations comprising:
receiving a request for quotation for an inspection job from a client;
determining initial job information from the request and predetermined information stored in a database;
preparing a quotation for the inspection job;
providing access to the quotation to the client;
determining an approval status of the quotation;
receiving detailed job information from an inspector;
preparing one or more job reports for the inspection job;
storing the one or more job reports in the database;
providing access to the one or more job reports;
preparing a billing authorization for the inspection job; and
providing access to the billing authorization to the client.

2. The method of claim 1, further comprising:
storing the quotation for the inspection job in the database.

3. The method of claim 1, further comprising:
storing the billing authorization for the inspection job in the database.

4. The method of claim 1, further comprising:
managing rights and privileges of users.

5. The method of claim 4, wherein users comprise one or more administrators, management, finance representatives, inspectors, and clients.

6. The method of claim 1, further comprising:
providing linkage to an external software application.

7. The method of claim 6, wherein the external application comprises a spreadsheet software application, a financial software application, or a reporting software application.

8. The method of claim 1, wherein the detailed job information comprises one or more of safety observations, inspection measurement data, inspection photographs, inspection videos, inspection reports, and historical data.

9. The method of claim 1, wherein the one or more job reports comprise a safety observation checklist, an inspection report, or inspection photographs.

10. The method of claim 9, wherein the inspection report comprises one or more of a type of equipment inspected, identifying information of the equipment inspected, dimensions, measurement data, historical data, and acceptance or rejection criteria.

11. A non-transitory computer readable medium comprising software instructions that, when executed by a processor, perform a method of inspection management for energy operations comprising:
receiving a request for quotation for an inspection job from a client;
determining initial job information from the request and predetermined information stored in a database;
preparing a quotation for the inspection job;
providing access to the quotation to the client;
determining an approval status of the quotation;
receiving detailed job information from an inspector;
preparing one or more job reports for the inspection job;
storing the one or more job reports in the database;
providing access to the one or more job reports;
preparing a billing authorization for the inspection job; and
providing access to the billing authorization to the client.

12. The non-transitory computer readable medium of claim 11, further comprising:
storing the quotation for the inspection job in the database.

13. The non-transitory computer readable medium of claim 11, further comprising:
storing the billing authorization for the inspection job in the database.

14. The non-transitory computer readable medium of claim 11, further comprising:
managing rights and privileges of users.

15. The non-transitory computer readable medium of claim 14, wherein users comprise one or more administrators, management, finance representatives, inspectors, and clients.

16. The non-transitory computer readable medium of claim 11, further comprising:
providing linkage to an external software application.

17. The non-transitory computer readable medium of claim 16, wherein the external application comprises a spreadsheet software application, a financial software application, or a reporting software application.

18. The non-transitory computer readable medium of claim 11, wherein the detailed job information comprises one or more of safety observations, inspection measurement data, inspection photographs, inspection videos, inspection reports, and historical data.

19. The non-transitory computer readable medium of claim 11, wherein the one or more job reports comprise a safety observation checklist, an inspection report, or inspection photographs.

20. The non-transitory computer readable medium of claim 11, wherein the inspection report comprises one or more of a type of equipment inspected, identifying information of the equipment inspected, dimensions, measurement data, historical data, and acceptance or rejection criteria.
